(19) United States
(12) Patent Application Publication
(10) Pub. No.: US 2016/0362032 A1
(43) Pub. Date: Dec. 15, 2016

(54) CONTAINER RECEIVING DEVICE FOR A VEHICLE INTERIOR

(71) Applicants: Hartmut BOHLKE, Wuppertal (DE); Hartmut HEINE, Solingen (DE); Philipp WOLTER, Langenfeld (DE)

(72) Inventors: Hartmut BOHLKE, Wuppertal (DE); Hartmut HEINE, Solingen (DE); Philipp WOLTER, Langenfeld (DE)

(21) Appl. No.: 15/182,181

(22) Filed: Jun. 14, 2016

(30) Foreign Application Priority Data
Jun. 15, 2015 (DE) 10 2015 210 979.8

(51) Int. Cl. B60N 3/10

(52) U.S. Cl. CPC B60N 3/103

(57) ABSTRACT

Such a container receiving device having a receiving frame which encloses at least one container recess and having a receiving bottom where at least one container can be placed on, is known.

According to the invention, a support cover is assigned to the receiving frame in the vicinity of a top side, which cover is mounted to be displaceable in height relative to the receiving frame between a lower rest position and an upper support position by means of a lifting mechanism, and a mechanically releasable locking device is assigned to the support cover, and by means of said locking device the support cover is fixed in the lower rest position.

Use in passenger vehicles

### CROSS-REFERENCE TO RELATED APPLICATIONS

This claims priority from German Patent Application No. 10 2015 210 979.8, filed Jun. 15, 2015, the disclosure of which is hereby incorporated by reference in its entirety into this application.

### FIELD OF THE INVENTION

The invention relates to a container receiving device for a vehicle interior, having a receiving frame which encloses at least one container recess, and having a receiving bottom where at least one container can be placed on.

### BACKGROUND OF THE INVENTION

Such a container receiving device for a vehicle interior of a passenger automotive vehicle is well-known. The container receiving device is positioned in a center console of the vehicle interior and has a dimensionally stable receiving frame which encloses two container recesses. The container recesses are downwards delimited by a receiving bottom which is fixedly connected to the receiving frame. Containers inserted in the container recesses within the receiving frame rest on the receiving bottom with their undersides.

### SUMMARY OF THE INVENTION

It is the object of the invention to provide a container receiving device of the above mentioned type which allows improved supporting of at least one container in a vehicle interior.

This object is achieved in that a support cover is assigned to the receiving frame in the vicinity of a top side, which cover is mounted to be displaceable in height relative to the receiving frame between a lower rest position and an upper support position by means of a lifting mechanism, and in that a mechanically releasable locking device is assigned to the support cover, and by means of said locking device the support cover is fixed in the lower rest position. The support cover encloses the at least one container recess above the receiving frame preferably completely and has a frame-type design. Advantageously, two adjacent container recesses are provided which are defined by the receiving frame. Also, the support cover preferably encloses both container recesses above the receiving frame. The support cover in the lower rest position thereof can also be positioned on the level of the receiving frame. In any case, the support cover in the upper support position thereof is positioned at a distance above an upper edge of the receiving frame. The container receiving device according to the invention is with particular advantage appropriate for use in the vicinity of a center console or in the vicinity of a center armrest unit of a passenger vehicle. The container receiving device can, however, also be employed with other types of wheeled or railway vehicles or also in aircraft or water craft vehicles.

In an embodiment of the invention, a control mechanism is assigned to the receiving bottom, which mechanism is operatively connected to the locking device in order to release the locking device upon activation of the control mechanism. The control mechanism is disposed in the vicinity of the receiving bottom such that, in a particularly advantageous manner, when a container is placed on the receiving bottom, the support cover is displaced to the upper support position in a self-acting manner, or otherwise can be displaced manually to the upper support position.

In a further embodiment of the invention, the lifting mechanism is pre-tensioned in the lower rest position of the support cover by a spring drive such that the lifting mechanism transfers the support cover to the support position after releasing of the locking device in a self-acting manner. This is a particularly advantageous embodiment, since the support cover is automatically displaced to the upper support position upon placing a container in the receiving frame and on the receiving bottom.

In a further embodiment of the invention, the receiving bottom is part of the control mechanism. Consequently, the control mechanism is activated when a corresponding container is placed on the receiving bottom, or when by other ways and means, in particular by pressure of a hand, a compressive force is exerted on the receiving bottom from above.

In a further embodiment of the invention, the locking device includes a latching mechanism cooperating with at least one latching element on the support cover, and which mechanism is disposed below the receiving bottom. Consequently, the latching mechanism is concealed by the receiving bottom and at least largely invisible.

In a further embodiment of the invention, the latching mechanism includes at least one latching slider displaceable in parallel to the receiving bottom, which slider cooperates with the latching element of the support cover. Preferably, two latching sliders are provided and shiftable in mutually opposed directions. The at least one latching slider is positioned below the receiving bottom.

In a further embodiment of the invention, the at least one latching slider is spring-loaded in the direction towards the latching position thereof. What is ensured thereby is that the at least one latching slider will always return to the latching position when in the unloaded condition.

In a further embodiment of the invention, the receiving bottom is displaceable in height in the vertical direction of the receiving frame to a limited extent. Consequently, the locking device is controllable owing to a corresponding displacement in height of the receiving bottom.

In a further embodiment of the invention, the receiving bottom is provided with a control ramp on the underside thereof, which ramp is in operative connection to the latching slider, and upon lowering the receiving bottom to a use position, the latching slider is shifted in the direction towards its release position. Preferably, the control ramp is implemented by a wedge on the underside of the receiving bottom, and the wedge acts synchronously on two latching sliders shiftable in mutually opposed directions. As a result, synchronized and simultaneous transferring of both latching sliders to a detached position and, consequently, to a release position of the at least one latching element of the support cover is allowed. Advantageously, there are also two complementary latching elements assigned to the two latching sliders in the vicinity of the support cover, which elements preferably are designed as latching studs or latching lugs.

In a further embodiment of the invention, the receiving bottom is retained in an upper non-use position using spring elements in an unloaded condition. In the non-use position, the receiving bottom is spaced to the at least one latching slider so that said slider remains in its latching position.

Further advantages and features of the invention will become apparent from the claims and from the description below of a preferred exemplary embodiment of the invention which is illustrated with reference to the drawings.

### BRIEF DESCRIPTION OF THE DRAWINGS

FIG. 1 shows a schematic illustration of an embodiment of a container receiving device according to the invention having a support cover displaceable in height, secured in its lower rest position;

FIG. 2 shows the container receiving device according to FIG. 1 with a support cover shifted to an upper support position;

FIG. 3 shows the container receiving device according to FIGS. 1 and 2 in a partially sectioned perspective illustration obliquely from below;

FIG. 4 shows the illustration according to FIG. 3, wherein two latching sliders are shifted to their release position;

FIG. 5 shows a schematic illustration of a cross section through the container receiving device according to FIG. 1 in a lower rest position of the support cover; and

FIG. 6 shows in a cross sectional illustration according to FIG. 5 the container receiving device of FIG. 5, however, with the support cover in an upper support position according to FIG. 2.

### DETAILED DESCRIPTION

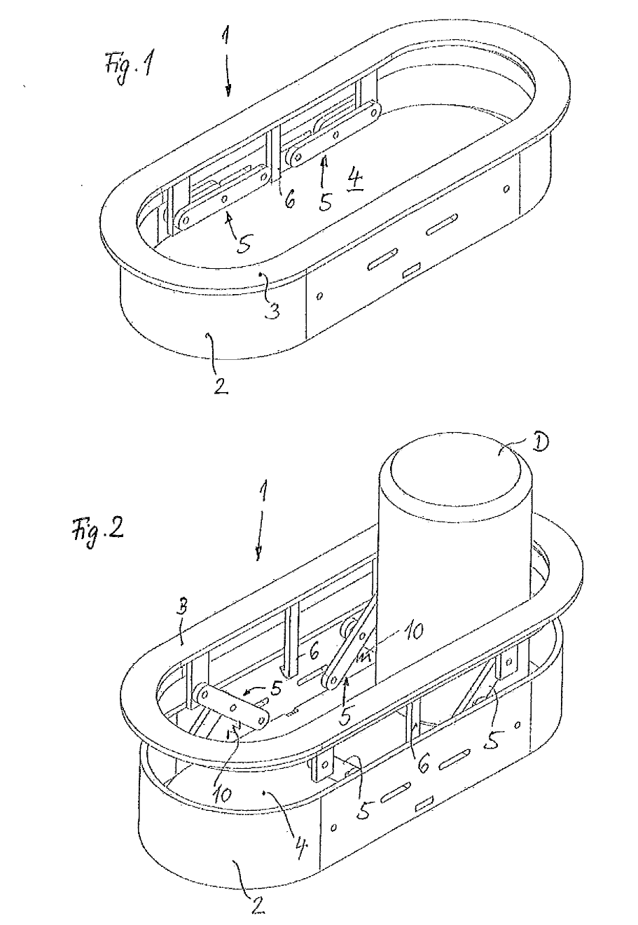

A container receiving device 1 according to FIGS. 1 to 6 is intended for installation in a center console or in a pivotable center armrest unit of a passenger vehicle. The container receiving device 1 includes a receiving frame 2 which comprises circumferential lateral walls extending in the vertical direction. In the embodiment as illustrated, the receiving frame 2 has an oval-type outer contour, as seen from above, and defines two adjacent container recesses which continuously merge into one another. With reference to FIG. 2 it is apparent that a container recess is provided to enclose a container, in the present case in the form of a can D.

An upper boundary region of the receiving frame 2 is covered by a support cover 3 which retraces the oval-type shape of the receiving frame 2 and surrounds the two container recesses likewise in the type of a frame. The support cover 3 with its surface is not oriented vertically, like the lateral walls of the receiving frame 2, but rather in a horizontal plane. A receiving bottom 4 is mounted in the receiving frame 2, which bottom is positioned above a stationary frame bottom of the receiving frame 2. The frame bottom of the receiving frame 2 is integrally connected to the lateral walls of the receiving frame 2.

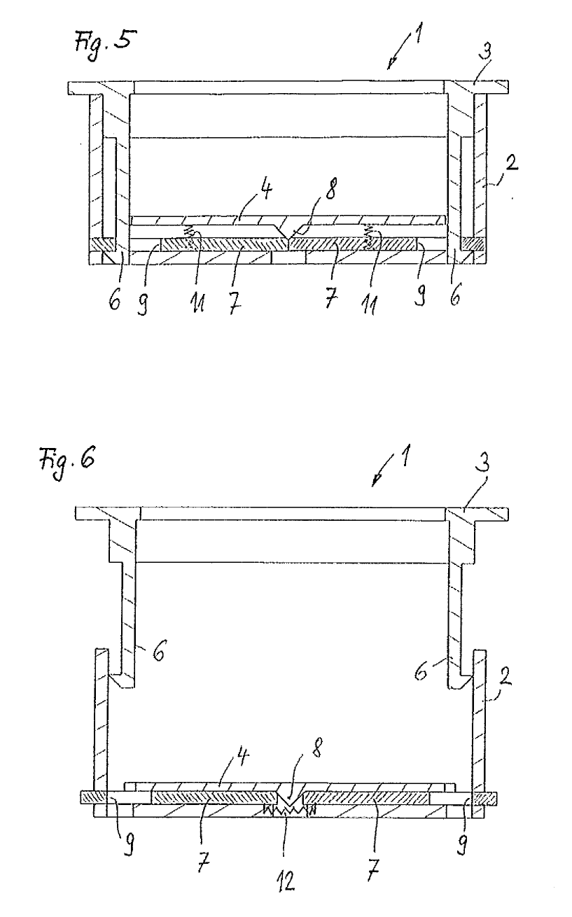

The receiving bottom 4 extends in parallel to the surface of the support cover 3 in a horizontal plane and has a planar design. The receiving bottom 4 is displaceable in height in the vertical direction within the receiving frame 3 to a limited extent, as is apparent with reference to FIGS. 5 and 6. To that end, guiding members (not illustrated in more detail) are assigned to the receiving bottom 4 and disposed on the receiving frame 3 and/or the receiving bottom 4. FIG. 5 illustrates an upper non-use condition of the receiving bottom 4. On the other hand, FIG. 6 shows a lower use condition of the receiving bottom 4. In an unloaded non-use condition the receiving bottom 4 is retained in its upper final position using spring elements 11, wherein the spring elements 11, in the exemplary embodiment as illustrated, rest between the frame bottom of the receiving frame 3 and the receiving bottom 4 and are designed as compression springs.

The support cover 3 is also disposed to be displaceable in height relative to the receiving frame 2. To that end, a lifting mechanism 5 is provided which, in the exemplary embodiment as illustrated in FIGS. 1 and 2, is composed of multi-articulated hinges. The multi-articulated hinges are designed such that the support cover 3 is displaced in parallel in the vertical direction, i.e. in height, between the lower rest position according to FIG. 1 and an upper support position according to FIG. 2. Consequently, the lifting mechanism 5 ensures a dislocation of the support cover 3 in height, wherein the surface of the support cover 3 always remains in a horizontal position between the lower rest position and the upper support position. In order to displace the support cover 3 in height from the lower rest position in the direction towards the upper support position in a self-acting manner, a spring drive 10 is assigned to the lifting mechanism 5, which drive in the exemplary embodiment as illustrated is composed of a plurality of spring units which apply torque to the multi-articulated hinges in the direction towards the upper support position. Consequently, the spring drive 10 causes an automatic transfer of the lifting mechanism 5 to the upper support position of the support cover 3, as long as there is no greater counter force acting on the support cover 3 from above.

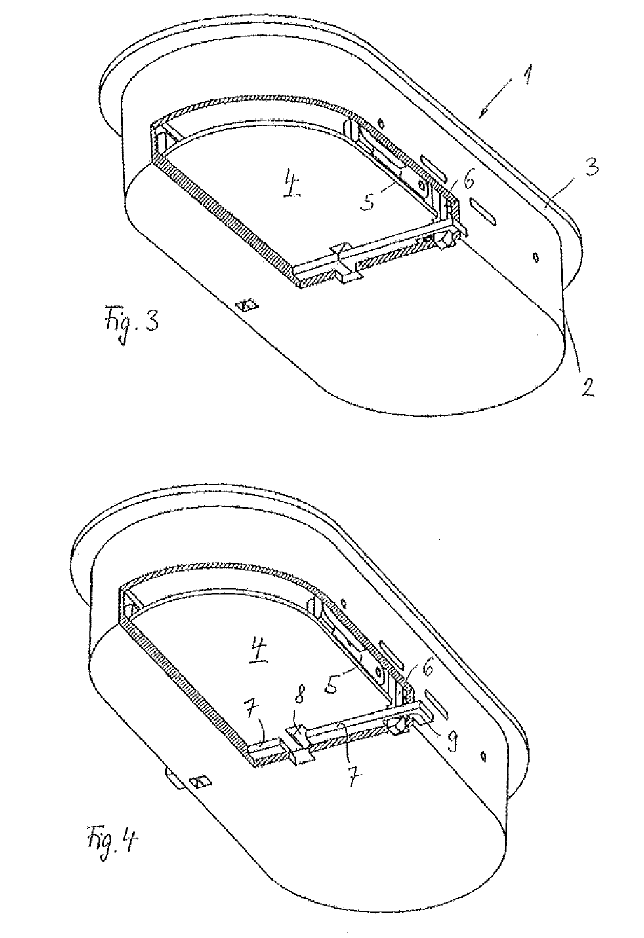

The support cover 3 is retained in its rest position on the receiving frame 2 by a locking device. In the exemplary embodiment as illustrated, the locking device is constituted by two downwards projecting support prolongations 6 of the support cover, which are disposed on opposite longitudinal sides of the support cover 3 in a diametrically opposite central location and project downwards in the vertical direction. At is apparent with reference to FIGS. 3 to 6 the two support studs 6 each have an outwards pointing latching lug on the lower face ends thereof. The support studs 6 are integrally molded to the support cover 3. In the rest position of the support cover 3 the support studs 6 protrude through lateral recesses of the receiving bottom 4 and up to a location below the receiving bottom 4. Both the latching lugs are positioned below the receiving bottom 4. In addition, the locking device comprises two latching sliders 7 which are mounted below the receiving bottom 4 to be shiftable in parallel to the receiving bottom 4. Both the latching sliders 7 extend transversely to the longitudinal extension of the receiving frame 2 between the opposite latching studs 6 and each include a latching recess 9 with the respective latching stud 6 projecting through said recess in the lower rest position of the support cover 2. The latching lugs of the support studs 6 engage under the two latching sliders 7. The frame bottom of the receiving frame 3 includes guiding tracks (not illustrated in more detail) which allow linear guidance of the latching sliders 7. It is apparent with reference to FIG. 6 that the latching sliders are guided in the vicinity of the opposite lateral walls of the receiving frame 3 also in corresponding passages. The latching sliders 7 project laterally outwards beyond the lateral walls of the receiving frame 3 when in their release position according to FIG. 6. When in the locking position according to FIG. 5, the latching sliders 7 rest against each other with their mutually opposed face end regions. It is apparent with reference to FIG. 6 that a spring unit 12 extends between the latching sliders 7 in the vicinity of the frame bottom of the receiving frame 3, which spring is designed as a tension spring device, and the two latching sliders 7 are spring-loaded in the direction towards their latching position, also referred to as locking position. Consequently, the latching sliders 7, when in their latching position, rest against each other due to corresponding pre-tensioning of the spring unit 12 according to FIG. 5. The two latching sliders 7 in combination with the spring unit 12 and the support studs 6 together with the latching lugs thereof constitute the latching mechanism in the sense of the invention, which mechanism constitutes the locking device.

The receiving bottom 4 has on the underside thereof a control ramp in the form of a control wedge 8, which is positioned centrally above the face end regions of the latching sliders 7 resting against each other. The control wedge 8 has a downwards tapering wedge shape of triangular cross section, with the tip thereof being positioned at the joint between the end face regions of the latching sliders 7 in the non-use condition of the receiving bottom 4. The receiving bottom and the control wedge 8 constitute a control mechanism in the sense of the invention in the exemplary embodiment as illustrated.

In the lower rest position of the support cover 2 the latching lugs of the support studs 6 are latched behind the latching recesses of the latching sliders 7 according to FIG. 5. Since the spring drive 10 exerts a permanent spring force on the lifting mechanism 5 in the lifting direction upwards, the latching lugs of the support studs 6 are also secured in said locking position. As long as there is no compressive force exerted on the receiving bottom 4 from above, the receiving bottom 4 will remain in its non-use condition according to FIG. 5, wherein the control wedge 8 is positioned immediately above the joint between the two latching sliders 7. Once a compressive force is exerted on the receiving bottom 4 from above, be it by manual compressive force or by a weight of a container in the form of a can D (FIG. 2), the receiving bottom 4 is lowered downwards in parallel. Thereby, the inclined planes of the control ramp in the form of the control wedge 8 urge the latching sliders 7 apart in opposite directions (FIG. 6), whereby the latching recesses 9 are also shifted outwards towards the respective side wall of the receiving frame 3. Once the control wedge 8 is completely plunged between the latching sliders 7, the latching recesses 9 are shifted far enough outwards that the latching lugs of the support studs 6 are released. As a result, the spring drive 10 of the lifting mechanism 5 urges the support cover 2 into its upper support position. Said upper support position of the support cover 2 is secured by respective end stops (not illustrated). Thus, the support cover 3 is positioned spaced to an upper boundary region of the receiving frame 2, as apparent with reference to FIG. 2, whereby a snug lateral support of the can D may be achieved. Once the can D is lifted off the receiving bottom 4 and removed from the receiving frame 2 and there is no further compressive force acting from above on the receiving bottom 4, the spring elements 11 urge the receiving bottom 4 back to its non-use condition according to FIG. 5. In case the support cover 2 is pressed back down manually by pressure from above, the latching lugs 6 in the vicinity of the latching recesses 9 again abut on the latching sliders 7 from above. The latching lugs of the support studs 6 include ramp surfaces, as apparent with reference to FIGS. 5 and 6, which abut during downwards pressing on corresponding boundary regions of the latching recesses 9 and necessarily urge said boundary regions outwards towards the side walls of the receiving frame 3, whereby the latching lugs can slide through the latching recesses 9. Once the support cover 2 has reached its lower rest position, wherein the cover rests on the upper boundary region of the receiving frame 3, the latching lugs are likewise moved up to a location below the latching recess 9, whereby the spring unit 12 draws the latching sliders 7 back inwards in the direction towards the locking position thereof, until the latching sliders 7 meet at the joint. Thus, the locking position of the latching lugs and the latching sliders 7 is resumed, and the support cover 2 is blocked in the lower rest position according to FIG. 5.

1. Container receiving device (1) for a vehicle interior, having a receiving frame (2) which encloses at least one container recess, and having a receiving bottom (4) where at least one container (D) can be placed on, characterized in that a support cover (3) is assigned to the receiving frame (2) in the vicinity of a top side, which cover is mounted to be displaceable in height relative to the receiving frame (2) between a lower rest position and an upper support position by means of a lifting mechanism (5), and in that a mechanically releasable locking device (6, 7, 9) is assigned to the support cover (3), and by means of said locking device the support cover (3) is fixed in the lower rest position.

2. Container receiving device according to claim 1, characterized in that a control mechanism (8, 12) is assigned to the receiving bottom (4), which mechanism is operatively connected to the locking device in order to release the locking device upon activation of the control mechanism.

3. Container receiving device according to claim 1, characterized in that the lifting mechanism (5) is pre-tensioned in the lower rest position of the support cover (3) by a spring drive (10) such that the lifting mechanism (5) transfers the support cover (3) to the support position after releasing of the locking device in a self-acting manner.

4. Container receiving device according to claim 2, characterized in that the receiving bottom (4) is part of the control mechanism.

5. Container receiving device according to any one of the preceding claims, characterized in that the locking device includes a latching mechanism (6, 7, 9) cooperating with at least one latching element (6) on the support cover (3) and disposed below the receiving bottom (4).

6. Container receiving device according to claim 5, characterized in that the latching mechanism includes at least one latching slider (7) displaceable in parallel to the receiving bottom (4), which slider cooperates with the latching element (6) of the support cover (3).

7. Container receiving device according to claim 6, characterized in that the at least one latching slider (7) is spring-loaded in the direction towards the locking position thereof.

8. Container receiving device according to any one of the preceding claims, characterized in that the receiving bottom (4) is displaceable in height in the vertical direction of the receiving frame (2) to a limited extent.

9. Container receiving device according to claim 8, characterized in that the receiving bottom (4) is provided with a control ramp (8) on the underside thereof, which ramp is in operative connection to the latching slider (7), and when lowering the receiving bottom (4) to a use position, the latching slider (7) is shifted in the direction towards the release position thereof.

10. Container receiving device according to claim 9, characterized in that the receiving bottom (4) is retained in an upper non-use position using spring elements (11) in an unloaded condition.
